(19) United States
(12) Patent Application Publication
(10) Pub. No.: US 2009/0305057 A1
(43) Pub. Date: Dec. 10, 2009

(54) Deposition process

(76) Inventor: Liang Ye, Merseyside (GB)

Correspondence Address: MARSHALL & MELHORN, LLC, FOUR SEAGATE - EIGHTH FLOOR, TOLEDO, OH, 43604, US

(21) Appl. No.: 11/991,190

(22) PCT Filed: Sep. 11, 2006
(86) PCT No.: PCT/GB2006/003338

§ 371 Date: Apr. 24, 2009

(30) Foreign Application Priority Data
Sep. 9, 2005 (GB) 0518383.5

(51) Int. Cl. B32B 17/06; C03C 17/06

(52) U.S. Cl. 428/432; 65/60.52; 65/60.2

(57) ABSTRACT

A zinc oxide coating is deposited onto the surface of a continuous glass ribbon during a float glass production process using a chemical vapor deposition process in which the vapor comprises a dialkyl zinc precursor and at least one oxygen containing organic compound which is preferably ethyl acetate. The conductivity of the coating may be increased by introducing a dopant such as fluorine or aluminum. The coated glass is useful in solar control and low emissivity glazing.

This invention relates to novel processes for the deposition of a coating comprising a zinc oxide upon the surface of a continuous glass ribbon during a float glass production process. Certain of the coated glass ribbons produced by these processes are believed to be novel and comprise a second aspect of the invention.

Transparent conductive coatings comprising a zinc oxide have been applied to glass substrates. The coated glass is potentially useful in a variety of applications including solar control glazings and low emissivity glazings. The coatings have most commonly been applied using sputtering techniques.

A variety of coatings comprising a metal oxide have been applied to a continuous glass ribbon during a float glass production process. Generally they have been applied using a chemical vapor deposition process (hereinafter for convenience a CVD process) in which a vapor comprising a precursor of the metal oxide is brought into contact with the glass ribbon at a point where the temperature of the ribbon is sufficient to drive the deposition reaction. In order to be useful the process must deposit a coating of the requisite quality at a deposition rate which is sufficiently high to give a coating of the desired thickness in the time available and utilize precursors which can be volatilized and delivered to the ribbon without any significant pre reaction having taken place. There is an on going need for processes which meet these criteria and produce the desired product in an economic manner.

There have been proposals to deposit a coating comprising a zinc oxide on glass using a CVD process.

U.S. Pat. No. 4,751,149 discloses processes in which an organo zinc precursor such as diethyl zinc and an oxidant are brought into contact with a glass substrate in a closed chamber at a temperature of from 60° C. to 350° C. The pressure within the chamber is preferably from 0.1 to 2.0 torr. The use of a closed chamber and the low reaction rates (600 Angstroms per minute) render these processes unsuitable for use in coating a continuous glass ribbon.

U.S. Pat. No. 4,990,286 discloses processes for the deposition of a fluorinated zinc oxide coating on glass using diethyl zinc and an oxygen containing compound which may be an alcohol, water or oxygen where the glass is at a temperature of from 350° C. to 500° C. The deposition takes place over a period of minutes which renders these processes not suitable for use in coating a continuous glass ribbon.

U.S. Pat. No. 6,071,561 discloses processes which utilize a chelate of a dialkyl zinc compound as the precursor but are otherwise similar to those of U.S. Pat. No. 4,990,286. Once again the deposition takes place over a period of minutes and the processes are thereby not suitable for coating a continuous glass ribbon.

U.S. Pat. No. 6,416,814 discloses processes for the deposition of tin, titanium or zinc oxides using ligated compounds of these metals. It is stated that these ligated compounds are contacted with glass at a temperature of from 400° C. to 700° C. and no additional oxidant is used. No details of a process which deposits a zinc oxide coating are disclosed.

We have now discovered a CVD process for the deposition of a zinc oxide coating can be deposited rapidly and effectively on the surface of a float glass ribbon at point where the temperature of the ribbon is in the range 500° C. to 700° C. in which the vapor phase comprises a dialkyl zinc compound and an oxygen containing organic compound. Accordingly from a first aspect this invention provides a process for the deposition of a coating comprising a zinc oxide on the surface of a continuous glass ribbon during a float glass production process which comprises forming a fluid mixture comprising a dialkyl zinc compound having the general formula R₂Zn wherein R represents an alkyl group comprising from 1 to 4 carbon atoms and an oxygen containing organic compound and bringing said mixture into contact with the surface of the glass ribbon at a point where the temperature of the glass is in the range 500° C. to 700° C.

The preferred dialkyl zinc compounds are those wherein the group R represents a methyl group or an ethyl group i.e. the preferred compounds are dimethyl zinc and diethyl zinc.

The oxygen containing organic compound may be any compound which is sufficiently volatile at atmospheric pressure to be incorporated into the vapor phase with the dialkyl zinc compound at a temperature which is below that at which it reacts with the dialkyl zinc compound. The preferred organic compounds are aliphatic alcohols and carboxylic acid esters.

Where the organic oxygen containing compound is an ester it is preferably an ester having the general formula R′—C(O)—O—C(XX)—C(YY′)R″ wherein R′ and R″ which may be the same or different represent alkyl groups comprising from 1 to 10 carbon atoms, X and X′, Y and Y′ which may be the same or different represent hydrogen atoms or alkyl groups comprising from 1 to 4 carbon atoms with the proviso that at least one of Y or Y′ represents a hydrogen atom.

More preferably the ester is one having this general formula wherein R′ represents an alkyl group comprising from 1 to 4 carbon atoms. Most preferably R′ represents an ethyl group.

Where the oxygen containing compound is an alcohol it is preferably an aliphatic alcohol comprising from 1 to 6 and most preferably from 1 to 4 carbon atoms.

The preferred oxygen containing organic compounds for use in the processes of the present invention are ethyl formate, ethyl acetate, ethyl propionate, ethyl butyrate, n-propyl formate, n-propyl acetate, n-propyl propionate, n-propyl butyrate, isopropyl formate, isopropyl acetate, isopropyl propionate, isopropyl butyrate, n-butyl formate, n-butyl acetate, sec butyl acetate, t butyl acetate, ethanol, propanol, isopropanol, n butanol, isobutanol and t butanol.

A mixture of two or more organic oxygen containing compounds may be employed. In one preferred embodiment the mixture comprise at least one ester and at least one alcohol. The most preferred mixture comprises ethyl acetate and isopropanol. In the preferred embodiments no other source of oxygen is employed. The presence of even a minor proportion of oxygen gas has been found to impair the deposition process and in the preferred embodiments oxygen is excluded from the fluid mixture.

The fluid mixture will normally comprise an inert carrier gas in which the dialkyl zinc compound and the oxygen containing organic compound are entrained. The most commonly used carrier gases are nitrogen and helium. The dialkyl zinc compound and the oxygen containing organic compound will preferably comprise from 1% to 10% by volume, more preferably from 3.0% to 4.5% by volume of the fluid mixture. In the more preferred embodiments the balance is provided solely by the inert carrier gas.

The molar ratio of the oxygen containing organic compound to the dialkyl zinc compound in the fluid mixture is preferably in the range 5:1 to 1:1, more preferably in the range 3:1 to 1:1 and most preferably in the range 2.5:1 to 1.5:1.

The temperature of the glass ribbon at the point where the fluid mixture is brought into contact with it is preferably in the range 500° C. to 650° C. and most preferably in the range 600° C. to 650° C. These temperatures are encountered in the float bath. In the float bath the glass ribbon is formed on the surface of a bath of molten tin. A reducing atmosphere is maintained in the bath so as to avoid the oxidation of the tin and the atmosphere is maintained at a slight plenum so as to minimize the ingress of air. The CVD processes which are used to coat the ribbon whilst it is in the bath are normally atmospheric pressure CVD processes as these can be operated in the atmosphere above the glass ribbon.

The coating may be deposited directly upon the glass ribbon or it may be deposited upon a coating which has already been deposited upon the ribbon. In another embodiment of the invention the. zinc oxide coating may be deposited on top of a silica coating. In a further embodiment it may be deposited on top of a metal oxide coating, in particular a tin oxide coating or a titanium oxide coating. In this embodiment the metal oxide may itself have been deposited on top of a silica coating.

The processes of this invention may also be used to produced a doped zinc oxide coating. In this embodiment of the invention a precursor of the dopant is introduced into the fluid mixture before it is brought into contact with the glass ribbon. Examples of dopants which have been proposed for incorporation into zinc oxide coatings include fluorine, boron, aluminum and molybdenum. Examples of precursors which may be incorporated into the fluid mixture in order to introduce these dopants include hydrogen fluoride, molybdenum carbonyl and dimethyl aluminum chloride. The presence of these dopants increases the conductivity of the zinc oxide coating. The proportion of dopant in the coating is relatively small normally the atomic ratio of zinc to dopant atom will be in the range 100:1 to 25:1 preferably 100:1 to 50:1. These doped zinc oxide coatings are useful as part of a coating which imparts solar control and/or low emissivity properties to the glass. The coatings produced by the processes of this invention can be used to produce coatings having a resistivity of less then 500 micron ohm cm and preferably less than 350 micron ohm cm. Continuous glass ribbons having a coating which comprises a zinc oxide coating having these low resistivities are believed to be novel and comprise a second aspect of this invention.

The processes of this invention may result in a zinc oxide coating being deposited at a rate of at least 200 Å/sec and more preferably at least 500 Å/sec. These relatively rapid deposition rates are advantageous when coating a continuous glass ribbon as part of a float glass production process. The ribbon is advancing continuously and is only available to be coated for a finite time. The fluid mixture is introduced to the surface of the glass ribbon through one or more coater heads. Faster deposition rates enable a thicker coating to be applied or a coating of a particular thickness to be applied using a smaller number of coater heads thus making other heads positioned over the ribbon available for the deposition of other coatings.

The preferred thickness of the zinc oxide coatings which may be deposited using the processes of this invention is in the range 200 Å to 5000 Å preferably 200 Å to 4000 Å. The thickness of coating which is deposited will be selected so as to be suitable for the purpose to which the coated glass is to be put.

### EXAMPLES

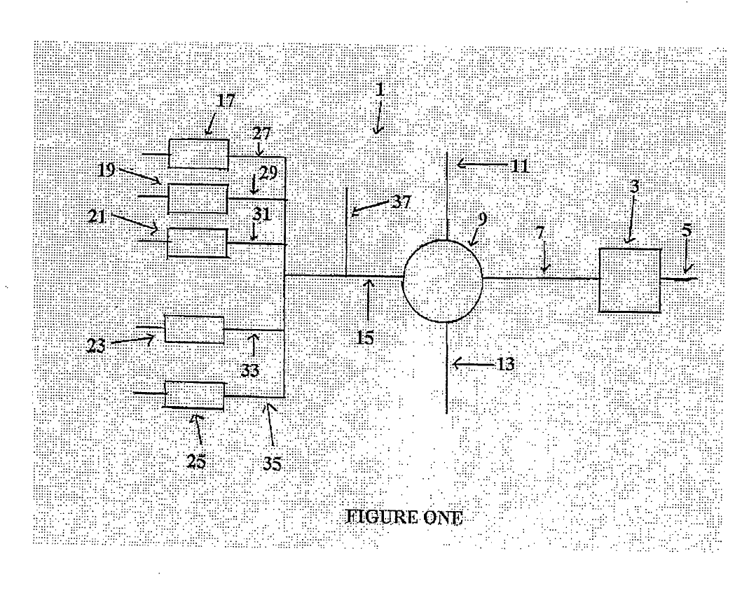

FIG. 1 illustrates schematically an example of a static chemical vapor deposition reactor and gas delivery system useful for carrying out the processes of the present invention and as used in Examples 1-6

In FIG. 1 a static chemical vapor deposition reactor and gas delivery system generally designated 1 comprises a reactor 3 having an outlet line 5 and an inlet line 7 both of which may be wound and heated with heating tape so as to reduce the likelihood of condensation in those lines. Line 7 connects to a four way valve 9. The other connections to the valve 9 are line 11 which connects to a purge gas source, line 13 which connects to a waste gas furnace and line 15 which connects to bubblers 17, 19, and 21 and to motorized heated syringes 23 and 25. Lines 27, 29 and 31 feed vapors produced in the bubblers to line 15. Lines 33 and 35 feed liquids injected from the syringe drivers into line 15. Line 37 connects to a nitrogen source.

All gas volumes are measured at standard temperature and pressure unless otherwise stated. The deposition process was continued in each case until the thickness of the zinc oxide coating was in the range 2000 Å to 2500 Å.

The results are summarized in Table 1

In Table 1 DEZ, represents diethyl zinc and DMZ represents dimethyl zinc

Examples 1 and 5 demonstrate processes for the deposition of a zinc oxide coating according to the invention. Examples 2, 3, 4 and 6 demonstrate processes for the deposition of a doped zinc oxide coating according to this. A comparison of the sheet resistance of the products demonstrates the increase in conductivity resulting from the presence of the dopants.

TABLE 1

| | Example | | | | | |
|---|---|---|---|---|---|---|
| | 1 | 2 | 3 | 4 | 5 | 6 |
| Zn precursor | DEZ 15 w % in | DEZ 15 w % in | DEZ 15 w % in | DEZ 15 w % in | DMZ (2.0M) in | DMZ (2.0M) in |
| | toluene | toluene | toluene | toluene | toluene | toluene |
| Substrate | Glass/SiO₂ | Glass/SiO₂ | Glass/SiO₂ | Glass/SiO₂ | Glass/SiO₂ | Glass/SiO₂ |
| Syringer 1 | DEZ 15 w % | DEZ 15 w % | | | | |
| Flow Rate | 1.85 ml/min | 1.85 ml/min | | | | |
| Temp ° C. | 70 | 70 | | | | |
| Syringer 2 | | | HF in water 15% | DMAC 1.0 M | | HF in water 15% |
| Flow Rate | | | 0.4 ml/min | 0.4 ml/min | | 0.22 ml/min |
| Temp ° C. | | | 100 | 120 | | 120 |
| Bubbler 1 | EtOAc | EtOAc | EtOAc | EtOAc | EtOAc | EtOAc |
| Temp ° C. | 45 | 45 | 47 | 56 | 49 | 48 |
| Carrier N₂ sccm | 1000 | 1000 | 1200 | 350 | 1200 | 450 |
| Bubbler 2 | | Mo(CO)₆ | DEZ 15 w % | DEZ 15 w % | DMZ (2.0M) | DMZ (2.0M) |
| temp ° C. | | 114 | 43 | 66 | 41 | 31 |
| Carrier sccm | | 250 | 1200 | 800 | 300 | 200 |
| Oxygen flow slm | | | | | | |
| N2 Balance flow | 7 | 7 | 6 | 5 | 5 | 7 |
| slm | | | | | | |
| Glass temp ° C. | 600 | 550 | 550 | 625 | 550 | 650 |
| Deposition perio [symbol] | 45 | 60 | 180 | 180 | 50 | 90 |
| sec | | | | | | |
| Resistance ohm | 6.5 × 10⁶ | 550 | 210 | 190 | 4 × 10⁶ | 300 |

[symbol]

indicates data missing or illegible when filed

A second series of examples 7 - 12 were carried our using a laboratory furnace having a conveyor enabling glass sheets to be moved through the furnace. The furnace contains a single ten inch wide bi directional coater. The coater is adapted to convey vaporized reactants to the surface of the glass sheet. The glass sheets were preheated to a temperature of 632° C. The glass sheets had a bilayer coating comprising a 250 Å thick layer of silica and a 250 Å thick layer of tin oxide. The zinc oxide has deposited on top of this bilayer.

The vapor streams are fed to the coater from source chambers referred to as bubblers which are maintained at specific temperatures. An inert gas stream is introduced into the bubblers at a controlled rate so as to entrain the reactant in that bubbler and to convey it to the coater and thereafter to the surface of the glass.

The results are presented as Table 2.

In this Table DEZ represents diethyl zinc. IPA represents isopropyl alcohol. In Example 7 a deposition process according to the invention has a high deposition rate but the zinc oxide coating has some powder on its surface. In Examples 9 and 10 a deposition process according to the invention has a slower deposition rate but there is no powder visible on the surface of the coating.

TABLE 2

| | Example | | | | | |
|---|---|---|---|---|---|---|
| | 7 | 8 | 9 | 10 | 11 | 12 |
| Zn precursor | DEZ pure | DEZ pure | DEZ pure | DEZ pure | DEZ pure | DEZ pure |
| Substrate | Glass/SiO₂/SnO₂ | Glass/SiO₂ | Glass/SiO₂/SnO₂ | Glass/SiO₂/SnO₂ | Glass/SiO₂/SnO₂ | Glass/SiO₂/SnO₂ |
| Bubbler 1 | DEZ | DEZ | DEZ | DEZ | DEZ | DEZ |
| temp ° C. | 100 | 100 | 100 | 100 | 100 | 100 |
| Carrier slm | 1.4 | 1.4 | 1.4 | 1.4 | 1.4 | 1.4. |
| Bubbler 2 | EtOAc | EtOAc | EtOAc | EtOAc | EtOAc | EtOAc |
| temp ° C. | 60 | 60 | 60 | 60 | 60 | 60 |
| Carrier slm | 0.05 | 0.15 | 0 | 0.5 | 0.1 | 0.15 |
| Bubbler 3 | IPA | IPA | IPA | IPA | IPA | IPA |
| temp ° C. | 60 | 60 | 60 | 60 | 50 | 50 |
| Carrier slm | 0 | 0 | 1.4 | 1.4 | 0.5 | 0 |
| Bubbler 4 | H₂O | H₂O | H₂O | H₂O | H₂O | H₂O |
| temp ° C. | 70 | 70 | 70 | 70 | 70 | 70 |
| Carrier slm | 0 | 0 | 0 | 0 | 0 | 0.1 |
| HF gas pure slm | 0 | 0 | 0 | 0 | 0 | 0 |
| N₂ dilution slm | 0 | 0 | 0 | 0 | 0 | 0 |
| O₂ slm | 0 | 0.025 | 0 | 0 | 0 | 0 |
| He Balance slm | 38 | 38 | 38 | 38 | 38 | 38 |
| Conveyor/ipm | 100 | 100 | 100 | 100 | 100 | 100 |
| Glass temp ° C. | 632 | 632 | 632 | 632 | 632 | 632 |
| Coating Å | 333 | 200 | 1500 | 1175 | 550 | 350 |

A third series of Examples 13 to 18 were carried out using a laboratory furnace which was similar to that used in Examples 7 to 12. The results are presented as table 3.

TABLE 3

| | Example | | | | | |
|---|---|---|---|---|---|---|
| | 13 | 14 | 15 | 16 | 17 | 18 |
| Zn precurs [symbol] | DEZ pure | DEZ pure | DEZ pure | DEZ pure | DEZ pure | DEZ pure |
| Substrate | Glass/SiO₂/ | Glass/SiO₂/ | Glass/SiO₂/ | Glass/SiO₂/ | Glass/SiO₂/ | Glass/SiO₂/ |
| | TiO₂ | TiO₂ | TiO₂ | TiO₂ | TiO₂ | TiO₂ |
| Bubbler 1 | DEZ | DEZ | DEZ | DEZ | DEZ | DEZ |
| temp ° C. | 85 | 85 | 85 | 85 | 85 | 85 |
| Carrier slm | 1 | 1 | 1 | 0.75 | 1 | 0.4 |
| Bubbler 2 | DEAC pure | DEAC pure | DEAC pure | DEAC pure | DEAC pure | DEAC pure |
| temp ° C. | 90 | 90 | 85 | 85 | 85 | 70 |
| Carrier slm | 0.6 | 0.6 | 0.15 | 0.15 | 0.09 | 0.2 |
| Bubbler 3 | IPA | IPA | IPA | IPA | IPA | IPA |
| temp ° C. | | 62 | 68 | 68 | 68 | 68 |
| Carrier slm | | 1.2 | 0.6 | 0.6 | 0.6 | 0.5 |
| Syringer 1 | IPA | | | | | |
| Flow rate | 3.5 | | | | | |
| cc/min | | | | | | |
| N2 Balance | 8 | 6 | 10 | 10 | 10 | 13.8 |
| slm | | | | | | |
| Conveyor/ | 27 | 27 | 27 | 27 | 27 | 27 |
| ipm | | | | | | |
| Glass temp [symbol] | 600 | 600 | 600 | 600 | 600 | 600 |
| Sheet R Ω/ [symbol] | 20 | 12 | 7 | 6 | 8 | 7 |

Coating thickness of above samples is between 3500 Å and 5000 Å [symbol]
indicates data missing or illegible when filed

1. A process for the deposition of a coating comprising a zinc oxide on the surface of a continuous glass ribbon during a float glass production process which comprises forming a fluid mixture comprising a dialkyl zinc compound having the formula R₂Zn wherein R represents an alkyl group comprising from 1 to 4 carbon atoms and an oxygen containing organic compound and bringing said mixture into contact with the surface of the glass ribbon at a point where the temperature of the glass is in the range 500° C. to 700° C.

2-23. (canceled)

24. A process according to claim 1, wherein the R represents an ethyl group.

25. A process according to claim 1, wherein R represents a methyl group.

26. A process according to claim 1, wherein the oxygen containing organic compound is an alcohol or a carboxylic acid eater.

27. A process according to claim 26, wherein the organic compound is an ester having the general formula R′—C(O)—O—C(XX′)—C(YY′)—R″ wherein R′ and R″ which may be the same or different, represent hydrogen atoms or alkyl groups comprising from 1 to 10 carbon atoms; X and X′, Y and Y′, which may be the same or different, represent hydrogen atoms or alkyl groups comprising from 1 to 4 carbon atoms with the proviso that at least one of Y or Y′ represents a hydrogen atom.

28. A process according to claim 27, wherein R′ is an alkyl group comprising from 1 to 4 carbon atoms.

29. A process according to claim 28, wherein R′ represents an ethyl group.

30. A process according to claim 1, wherein the oxygen containing organic compound is an aliphatic alcohol comprising from 1 to 6 carbon atoms.

31. A process according to claim 30, wherein the organic compound is an aliphatic alcohol comprising from 2 to 4 carbon atoms.

32. A process according to claim 1, wherein the oxygen containing organic compound is selected from the group consisting of ethyl formate, ethyl acetate, ethyl propionate, ethyl butyrate, n-propyl formate, n-propyl acetate, n-propyl propionate, n-propyl butyrate, n-butyl formate, n-butyl acetate, sec butyl acetate, t butyl acetate, ethanol, propanol, isopropanol, n butanol, isobutannol and t butanol.

33. A process according to claim 1, wherein the temperature of the glass ribbon is in the range 500° C. to 650° C.

34. A process according to claim 33, wherein the temperature of the glass is in the range 600° C. to 650° C.

35. A process according to claim 1, wherein the zinc oxide coating is deposited directly upon the glass ribbon.

36. A process according to claim 1, wherein the coating is a coating comprising a silica layer deposited on the glass ribbon prior to the deposition of the zinc oxide.

37. A process according to claim 1, wherein a coating comprising a tin oxide is deposited onto the glass ribbon prior to the deposition of the zinc oxide.

38. A process according to claim 1, wherein the zinc oxide coating is a doped zinc oxide coating and the fluid mixture further comprises a minor proportion of a precursor of that dopant.

39. A process according to claim 38, wherein the dopant is selected from the group consisting of molybdenum, fluorine and aluminum.

40. A process according to claim 1, wherein the zinc oxide coating is deposited at a rate of from 200 to 500 Å/sec.

41. A process according to claim 1, wherein the thickness of the zinc oxide coating which is deposited is in the range 200 to 5000 Å.

42. A continuous glass ribbon having a coating comprising a zinc oxide layer upon one surface wherein the layer has a resistivity of less than 500 micron ohm cm.

43. A ribbon according to claim 42, wherein the zinc oxide layer comprises a dopant.

44. A ribbon according to claim 43, wherein the dopant is selected from the group consisting of molybdenum, fluorine and aluminum.

45. A ribbon according to claim 42, wherein the resistivity of the zinc oxide layer is less than 350 micron ohm cm.
